(19) United States
(12) Patent Application Publication
(10) Pub. No.: US 2013/0146660 A1
(43) Pub. Date: Jun. 13, 2013

(54) SYSTEMS AND METHODS FOR AUTOMATING JURY ATTENDANCE VERIFICATION AND SERVICE PAYMENT

(71) Applicants: Paul Ehlers, Lubbock, TX (US); Raymond Richardson, Lubbock, TX (US)

(72) Inventors: Paul Ehlers, Lubbock, TX (US); Raymond Richardson, Lubbock, TX (US)

(21) Appl. No.: 13/709,920

(22) Filed: Dec. 10, 2012

Related U.S. Application Data
(60) Provisional application No. 61/570,021, filed on Dec. 13, 2011.

(51) Int. Cl. G06Q 20/08

(52) U.S. Cl. CPC G06Q 20/08
USPC 235/381

(57) ABSTRACT

Systems and methods of automating jury attendance verification and service payment are provided. A juror may report to for jury duty at the date/time identified on his/her jury summons and may be asked to provide the jury summons to check in for jury duty. The juror may present his/her summons to a juror-interaction machine that may read a personal identifier included on the summons. The machine may validate the personal identifier and confirm that the juror has checked in for jury service. At the conclusion of jury service, the machine may read the juror's summons containing a personal identifier and confirm that the juror has completed jury service. The machine may then dispense a cash payment to the juror. The machine also may capture a video clip or still image of the juror using the machine for verification and/or security.

### CROSS-REFERENCE TO RELATED APPLICATION

The present application claims priority to U.S. Provisional Application No. 61/570,021 filed De. 13, 2011, the disclosure of which is incorporated by reference herein in its entirety.

### FIELD OF THE DISCLOSURE

The present disclosure generally relates to jury service, and more particularly to systems and methods for automating jury attendance verification and service payment.

### BACKGROUND

When a juror arrives for jury duty, the process of attendance verification is generally a manual back-office task. When a juror completes his/her jury service, he/she has to wait to receive payment for the time spent in jury service. Payment is typically mailed to the juror once his/her jury service is complete, unless the juror has chosen to donate his/her jury service payment. The juror often does not receive jury service payment in the mail until at least 10-14 days after his/her jury service is complete.

### SUMMARY

Embodiments of the present disclosure may provide methods of automating jury attendance verification and service payment. A juror may report for jury duty on the date and time that he/she has been summoned to appear for jury duty (i.e., the date/time included on his/her jury summons). When the juror arrives for jury duty and reports, for example to the central jury room, he/she may be asked to provide all or a portion of the jury summons to check in for jury duty. The juror may present his/her summons to a machine that may read a personal identifier included on the summons. The machine may validate the personal identifier and confirm that the juror has checked in for jury service. Accordingly, the juror may check himself/herself in for jury duty, thereby speeding up the check-in process and freeing up court staff to complete other duties. At the conclusion of jury service, the machine may read the juror's summons containing a personal identifier and confirm that the juror has completed his/her jury service. The machine may then dispense a cash payment to the juror based on the number of days of jury service completed. The machine also may capture a video clip or still image of the juror using the machine, such as for security and verification purposes, according to embodiments of the present disclosure.

Embodiments of the present disclosure also may provide systems of automating jury attendance verification and service payment. Systems may include at least one juror-interaction machine, at least one entity server, and at least one communication network. Each juror-interaction machine may include at least a CPU to control any user interface and transaction mechanisms associated with the machine, a reader to validate the personal identifier associated with a jury summons, a display for a juror to interact with the machine, and a dispensing mechanism to provide a cash payment to the juror upon completion of jury service. The machine also may include a vault or safe that contains cash to dispense to jurors upon completion of jury service. The at least one juror-interaction machine may include at least one database to maintain files that may be transmitted to and/or received from at least one entity server over at least one communication network. The at least one juror-interaction machine also may include at least one input device so that a juror may interact with the juror-interaction machine. The at least one juror-interaction machine may further include a camera to capture video clips and/or still images of jurors that may utilize the machine. In embodiments of the present disclosure, the juror-interaction machine may include a record printer to provide a juror with a record of his/her interactions with the machine.

### BRIEF DESCRIPTION OF THE DRAWINGS

For a more complete understanding of this disclosure, reference is now made to the following description, taken in conjunction with the accompanying drawings, in which:

FIG. 1 depicts a method for automating jury service payment according to an embodiment of the present disclosure;

FIG. 2 depicts a system for automating jury service payment according to an embodiment of the present disclosure; and

FIG. 3 depicts a display on a juror payment system according to an embodiment of the present disclosure.

### DETAILED DESCRIPTION

Embodiments of the present disclosure may provide systems and methods for automating jury attendance verification and service payment. Such systems and methods may enhance the juror check-in process and enable jurors to receive payment for jury service immediately upon completion of jury service as compared to the past when jurors would often wait as much as several weeks to receive payment through regular U.S. mail. Accordingly, the juror compensation process may be streamlined and many of the problems associated with the issuance of checks by governmental entities may be reduced or even eliminated. Further, systems and methods according to embodiments of the present disclosure may provide jurors with the ability to check-in and receive payment by using a personal identifier associated with that particular juror that may be recognized and processed by a juror-interaction machine. Systems and methods according to embodiments of the present disclosure may minimize or eliminate overhead related to the juror payment process as well as enhance the payment experience for jurors.

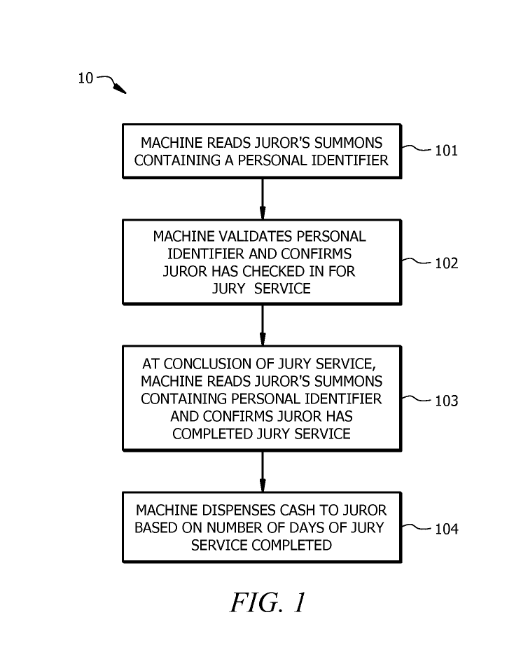

FIG. 1 depicts method 10 for automating jury service payment according to an embodiment of the present disclosure. A juror may report on the date and time that he/she has been summoned to appear (i.e., the date/time included on his/her jury summons). When the juror arrives for jury duty, he/she may be asked to provide all or a portion of the jury summons to check in for jury duty. In step 101, a juror may approach a juror-interaction machine and present his/her jury summons so that the machine may read the juror's summons containing a personal identifier. It should be appreciated that the personal identifier is unique to the particular juror. The personal identifier may be included on a hard copy of a jury summons sent to the juror by the entity issuing the summons, such as a county or district, through regular U.S. mail; however, in other embodiments of the present disclosure, a juror may be able to go online, such as through a secure website, prior to his/her jury service to receive or select a personal identifier that may be provided at the time that he/she checks in for jury service based, for example, on an email prompt provided by the entity issuing the summons. Accordingly, if the juror can remember the personal identifier selected online, then the juror may provide that personal identifier at the time of check-in even without having a hard copy of his/her jury summons. In a further embodiment of the present disclosure, a personal identifier may be made available to a juror when he/she logs into a secure website, and the juror may be able to present his/her personal identifier to a juror-interaction machine by having the machine read the personal identifier from his/her mobile phone or other communication device. This may address potential problems when a juror may forget a hard copy of the jury summons when appearing for jury service. It should be appreciated that a personal identifier may include but is not limited to a barcode, QR code, scannable image, identifying signal or other identifier according to embodiments of the present disclosure. In other embodiments of the present disclosure, a personal identifier may be a string of numbers, symbols and/or letters that a juror may be asked to enter into a juror-interaction machine at the time of jury service check-in and/or at the time when he/she requests jury service payment. A juror may enter such a string through an input device, such as a keyboard, a touch screen, or a keypad, that may be made available at the machine.

In step 102, the machine may validate the personal identifier and confirm that the juror has checked in for jury service. When the machine validates the personal identifier, it may accept the information provided by the juror and associate the personal identifier with the juror's mandatory attendance at jury duty. The machine may then store the juror information and relationship in a database. This may confirm that the juror is properly in attendance at jury duty (i.e., the juror showed up for jury duty on the correct day).

In step 103, at the conclusion of jury service, the machine again may read the juror's summons containing the personal identifier and confirm that the juror has completed his/her jury service. Accordingly, the juror identifies himself/herself to the juror-interaction machine using his/her personal identifier. The machine may validate the personal identifier as an active personal identifier. If the personal identifier is validated as “active,” the juror is eligible to receive pre-determined compensation (payment) for his/her jury service (i.e., the juror has not already received payment for jury service and the juror has completed his/her jury service).

When the juror-interaction machine evaluates a personal identifier, several reason codes may be associated with a personal identifier and appear on the display of the juror-interaction machine. For example, a reason code of “0” may indicate that a personal identifier has been approved for payment to be made. When the juror has been validated or approved, the amount of the juror's compensation may be displayed on the screen of the machine. A reason code of “1” may indicate that the personal identifier is invalid. A reason code of “2” may indicate that the personal identifier has expired. For security reasons, a database within the machine validating personal identifiers may set a time limit for which a personal identifier may be validated. Once outside of the time limit, the personal identifier expires. A reason code of “3” may indicate that payment has already been made with respect to the personal identifier. It should be appreciated that other reason codes may be utilized without departing from the present disclosure. The reason code may be displayed to the juror utilizing the machine once the personal identifier has been evaluated through the juror-interaction machine. Additionally or alternatively, the reason code may be transmitted to at least one entity server, for example, through an exception report according to embodiments of the present disclosure. It also should be appreciated that if a reason code is displayed indicating a problem with the jury summons, the screen may display a message indicating that the juror should present his/her summons to a manager for assistance. This message may be displayed when there are problems with an individual juror summons as well as when there may be problems with a given machine according to embodiments of the present disclosure. In other embodiments of the present disclosure, the machine may dispense a receipt indicating the problem so that the juror may provide the receipt to a manager when requesting assistance.

In step 104, the machine may dispense a cash payment to the juror based on the number of days of jury service completed. An exception report may be generated to record any malfunctions of the machine when dispensing payment. This exception report may be generated when a cash dispensing error occurs, for example, if the machine dispenses a $5 bill as opposed to a $1 bill.

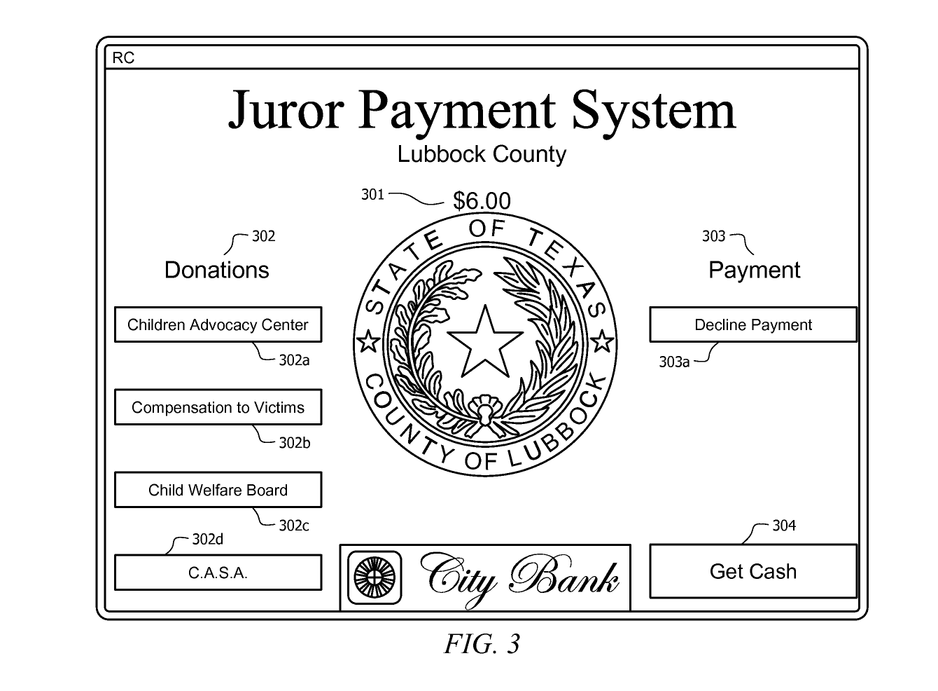

It should be appreciated that in other embodiments of the present disclosure, a juror may be presented with options other than receiving cash payment. FIG. 3 depicts a display on a juror payment system according to an embodiment of the present disclosure. In this embodiment, the juror may be notified of the amount that he/she is eligible to receive upon completion of jury service, and this amount may be depicted as payment 301. The juror may be presented with payment options 303 and donation options 302. With respect to payment options 303, the juror may receive cash payment by selecting “get cash” option 304. Alternatively, the juror may elect not to receive any cash payment by selecting “decline payment” option 303a. If a user declines payment, the payment may be retained by the entity managing the juror-interaction machine. With respect to donation options 302, the juror may elect to donate his/her cash payment to one or more charities. FIG. 3 depicts charities 302a, 302b, 302c, 302d as possible options for the juror to select according to an embodiment of the present disclosure. However, it should be appreciated that more, fewer or different charities may be presented as options for the juror to select without departing from the present disclosure. It should be appreciated that regardless what option a juror selects related to payment, a receipt may be issued to reflect the selection that the juror has made according to embodiments of the present disclosure. However, there may be embodiments where no receipt is issued when a cash payment is made except in circumstances when the system may have been unable to dispense a cash payment.

It should be appreciated that the machine also may capture a video clip or still image of the juror in conjunction with any of the steps set forth in FIG. 1, and the video clip or still image may be transmitted for storage or evaluation to at least one entity server associated with the entity controlling the machine. For example, once a personal identifier has been provided to the machine, the video clip and/or still image of the juror may be captured for security purposes. It should be appreciated that the video clip and/or still image may be transmitted to at least one entity server through at least one communication network and associated with the personal identifier. Accordingly, if the entity controlling the machine later determines that fraudulent activity may have occurred with respect to a transaction associated with a particular personal identifier, the entity may call up the video clip and/or still image to investigate the juror (i.e., whether the juror is actually the person who should be associated with that particular personal identifier). It also should be appreciated that the video clip and/or still image may be sent to at least one entity server simultaneously with a message to deactivate the personal identifier once jury service payment has been made. Alternatively, a message may be sent to at least one entity server to deactivate the personal identifier once jury service payment has been made followed by or before transmittal of the video clip and/or still image according to an embodiment of the present disclosure.

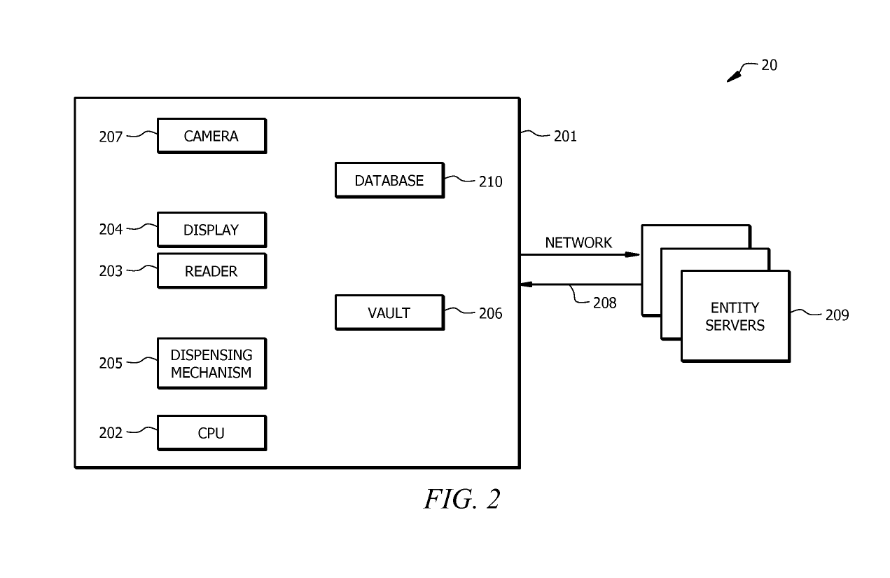

FIG. 2 depicts system 20 for automating jury service payment according to an embodiment of the present disclosure. System 20 may provide at least one juror-interaction machine 201, at least one entity server 209 and at least one communication network 208. Each machine 201 may include at least CPU 202 to control any user interface and transaction mechanisms associated with machine 201, reader 203 to validate the personal identifier associated with a jury summons, display 204 for a juror to interact with juror-interaction machine 201, and dispensing mechanism 205 to provide a cash payment to the juror upon completion of jury service. Machine 201 may include vault or safe 206 that contains the cash to dispense to jurors upon completion of jury service. Cash included in vault or safe 206 may generally be in the form of $5 and $1 bills; however, other denominations may be included in vault or safe 206 without departing from the present disclosure.

The machine also may include at least one database 210 to maintain files that may be transmitted to and/or received from at least one entity server 209 over at least one communication network 208. For example, once all of the jurors have been checked-in (such as in step 102 of FIG. 1), a file may be created and stored in database 210 identifying all jurors that have complied with their mandatory obligation to report for jury duty and should be eligible to receive jury service payment. The file may be stored in database 210 and then transmitted to at least one entity server 209 for further confirmation of eligibility prior to dispensing jury service payment. It should be appreciated that this file may be updated over the course of a day of jury service to confirm, for example, whether a juror may become eligible to receive more than one day of jury service payment. It also should be appreciated that the file may go through a batch process. For example, the file may be transmitted to at least one entity server 209 on a periodic basis during juror check-in so that the entity that controls machine 201 may confirm how many jurors have arrived and checked in for jury service, as jurors may check in at different times during a given day depending on the needs of the county or district. The file then may be used by machine 201 to validate a juror's personal identifier again prior to dispensing jury service payment. It should be appreciated that database 210, at least one entity server 209 or both may have control of a given file over the course of a day as the file may be replicated or released to be sent between machine 201 and at least one entity server 209 at various times during a given day.

Database 210 also may store information concerning the total amount of cash that has been dispensed to jurors on a day-to-day basis and/or the amount of cash remaining in machine 201 at any given time (i.e., a cash inventory log) such as for reconciliation purposes. When prompted by at least one entity server 209 and/or at a predetermined time (i.e., hourly, daily, weekly), machine 201 may send reports to at least one entity server 209 related to information stored in at least one database 210. In an embodiment of the present disclosure, at least one entity server 209 may request information from machine 201 in order to respond to an audit request. In other embodiments of the present disclosure, the entity that controls machine 201 may suspect fraudulent activity has occurred with respect to usage of machine 201 and may request that reports be sent to at least one entity server 209 in order to evaluate and address the problem.

Machine 201 also may include communication ports, such as serial data ports over data bus lines, wireless connections, or parallel connections, to communicate with other parts of system 20, such as at least one entity server 209, to receive and/or transmit information about, for example, juror check-in status, payments made to jurors, and errors in operation of machine 201 over network 208. Machine 201 may communicate with at least one entity server 209 through one or more communication networks 208. Communication may be wireline or wireless. For example, machine 201 may communicate with at least one entity server 209 through a Local Area Network (LAN), such as an Ethernet LAN. Wireless networks that may be used for communication between machine 201 and at least one entity server 209 may include, but are not necessarily limited to, wireless LAN, wireless mesh networks, wireless MAN, wireless WAN, mobile device networks (such as GSM or PCS), satellites, radio, Bluetooth, and Wi-Fi. Fiber optics also may be used for communication and/or data transmission as well as coaxial cables and/or twisted pair cables. Bus networks, ring networks, star networks, TCP/IP, ATM, and/or mesh networks also may be used as communication networks 208 according to embodiments of the present disclosure. Machine 201 also may include an operating system, such as Windows or Linux, or other application layer transaction protocols and programmable applications to enable machine 201 to communicate with at least one entity server 209 as well as with content servers or banking systems according to embodiments of the present disclosure.

Reader 203 of juror-interaction machine 201 may validate the personal identifier associated with a jury summons. It should be appreciated that reader 203 may be a handheld scanner associated with juror-interaction machine 201 or another scanning mechanism incorporated into or associated with machine 201 that may read and confirm data on the jury summons according to embodiments of the present disclosure. For example, reader 203 may be a conventional portable laser scanner similar to a scanner used to scan bar codes on goods in a grocery store wherein a red laser line may scan the bar code and the reader may make a sound when the summons has been read successfully. While a barcode scanning system may be used as reader 203, it should be appreciated that other types of readers may be used without departing from the present disclosure, including but not necessarily limited to, scannable image readers, signal readers or readers of other identifiers such as RFID and the like. In embodiments of the present disclosure, a juror may present his/her jury summons containing a personal identifier in hard copy form to be read by reader 203. It should be appreciated that the summons need not come into physical contact with reader 203. In other embodiments of the present disclosure, a juror may receive his/her summons via email or electronically (such as by logging into a web-based court system), and machine 201 may be configured to support scanning a juror's personal identifier directly from the juror's cellular phone or other communication device without departing from the present disclosure. It should be appreciated that any device or mechanism capable of communicating a personal identifier associated with a juror to machine 201 may be used without departing from the present disclosure.

Display 204 may prompt the juror through each step of the transaction process, such as the process depicted in FIG. 1. Display 204 may be configured in a manner similar to displays that may be provided on ATM machines according to embodiments of the present disclosure. However, it should be appreciated that display 204 may take any form that may be used to provide prompts or other indicators to a juror and otherwise allow the juror to interact with machine 201. In an embodiment of the present disclosure, display 204 may provide a touch screen that a juror may utilize, for example, to confirm whether he/she has served a certain number of days as a juror.

Associated with display 204, juror-interaction machine 201 also may include at least one input device so that a juror may interact with juror-interaction machine 201. The at least one input device may include, but is not necessarily limited to, a keyboard, a keypad, a PIN pad, a touch screen, and/or a tracking device, such as a mouse. The at least one input device may provide a plurality of keys for entering alphanumeric information, for scrolling through information made available on the display, for accessing additional information, for entering selected information, and the like. Using the at least one input device, the juror may respond to prompts shown on display 204.

In an embodiment of the present disclosure, machine 201 may include camera 207 to capture video clips and/or still images of jurors utilizing machine 201. Camera 207 may record an image of the juror when he/she comes within the field of view of camera 207. Use of camera 207 according to embodiments of the present disclosure may assist in avoiding fraudulent use of system 20, for example, by a person who obtains someone else's jury summons in an attempt to obtain that person's jury service payment. Camera 207 may be a video camera, still frame camera or other recording device that may be incorporated into machine 201 to capture a video clip or still image of each juror presenting his/her jury summons to be read by machine 201, either for juror check-in or for payment at the conclusion of jury service. It should be appreciated that camera 207 may be incorporated directly into the internal circuitry of machine 201; however, camera 207 also may be a conventional standalone video or still-frame camera according to embodiments of the present disclosure. It also should be appreciated that camera 207 may be used to capture color or black-and-white video clips or still images without departing from the present disclosure.

Embodiments of the present disclosure may provide that machine 201 may include a record printer to provide a juror with a record of his/her interactions with machine 201. This may include a receipt reflecting the payment amount that was dispensed to the juror. In other embodiments of the present disclosure, the record printer may be enabled to provide the juror with a certificate of completion of jury service that the juror may provide to his/her employer.

It should be appreciated that a personal identifier may be programmed such that it is only valid to be used for a specified period of time (an “open time period”). This open time period may be modified or adjusted by the entity that controls machine 201. In an embodiment of the present disclosure, a first juror may complete his/her jury service over the course of one day. Accordingly, that juror may collect the jury service payment at the conclusion of his/her day of jury service. However, a second juror may show up for jury service on the same day as the first juror but be selected to serve as a juror for a multi-day trial. Accordingly, the second juror would not be eligible for payment until the conclusion of the multi-day trial. Thus, the open time period for payment for the second juror would not open until his/her jury service is completed at the end of the multi-day trial. It should be appreciated that the open time period for payment according to embodiments of the present disclosure may remain open for 24 hours or another specified period in order to allow a juror who forgets to collect his/her payment on the day that his/her jury service is complete to come back the following day and collect payment using machine 201 without issue.

While systems and methods according to embodiments of the present disclosure may include a single juror-interaction machine, such as machine 201, for jurors to use when checking in for jury duty and/or receiving jury service payment, it should be appreciated that more than one machine may be provided, for example, in a central jury room or in another area within a courthouse, without departing from the present disclosure. The number of machines employed may be dependent on the budget or resources of the entity (i.e., county or district) that summons and pays the jurors. It also may be dependent on the amount of physical space available to position machines within a central jury room or in another area within a courthouse. It may further be dependent on the number of jurors that may be summoned for jury duty at a given time, and the number of machines employed may fluctuate depending on the number of jurors who may need to use the machines. For example, if a county summons more jurors than usual because of a high-profile trial, a county may rent or otherwise acquire additional machines to check-in and/or pay jurors. Upon completion of jury selection for that trial, the county may then reduce the number of machines.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A system for automating jury attendance verification and service payment, the system comprising:
at least one juror-interaction machine, each of the at least juror-interaction machines comprising at least one database to track information about jurors interacting with the machine, payments made to jurors through the machine, and the cash remaining in the machine, a reader to validate a personal identifier associated with a jury summons, a display for jurors to interact with the machine, and a dispensing mechanism to provide payment to jurors upon completion of jury service; and
at least one entity server, wherein information from the at least one database is transmitted between the at least one juror-interaction machine and the at least one entity server via at least one communication network.

2. The system of claim 1, the at least one juror-interaction machine further comprising:
a camera to capture video clips and still images of jurors utilizing the at least one juror-interaction machine.

3. The system of claim 1, the at least one juror-interaction machine further comprising:
a record printer to provide jurors with a record of transactions with the at least one juror-interaction machine.

4. The system of claim 1, the at least one juror-interaction machine further comprising:
a vault from which the dispensing mechanism obtains payment to provide to jurors.

5. A method for automating jury attendance verification and service payment, the method comprising:
receiving a personal identifier associated with a juror, the personal identifier provided to a juror-interaction machine;
communicating with at least one entity server to validate the personal identifier and confirm that the juror has completed jury service;
providing the juror with a selection mechanism displayable on the juror-interaction machine to elect whether to receive payment for having completed jury service; and
dispensing payment to the juror through the juror-interaction machine, the payment based on the number of days of jury service completed.

6. The method of claim 5 further comprising:
validating the personal identifier to confirm that the juror has checked in for jury service.

7. The method of claim 5 further comprising:
capturing an image of the juror providing the personal identifier to the juror-interaction machine; and
transmitting the image to the at least one entity server.

8. The method of claim 5 wherein the personal identifier is selected from the group comprising:
a bar code, a QR code, a scannable image, an identifying signal, a string of numbers, a string of letters, a string of symbols, and combinations thereof

9. The method of claim 5, wherein when the personal identifier is validated, a reason code is displayed on a screen of the juror-interaction machine, the reason code selected from the group comprising:
the personal identifier is approved, the personal identifier is invalid, the personal identifier has expired, payment has already been made with respect to the personal identifier, and there is a problem with the juror-interaction machine.

10. The method of claim 9 further comprising:
transmitting an exception report to the at least one entity server, the exception report including the reason code associated with the personal identifier.

11. The method of claim 5 wherein the communicating step is performed via at least one communication network, the at least one communication network selected from the group comprising:
a Local Area Network (LAN), a wireless LAN, an Ethernet LAN, a wireless mesh network, a wireless MAN, a wireless WAN, a GSM network, a PCS network, satellite, radio, Bluetooth, Wi-Fi, a fiber optic network, a bus network, a ring network, a star network, TCP/IP, and ATM.

12. A juror-interaction machine, the juror-interaction machine comprising:
at least one database to track information about jurors interacting with the machine, payments made to jurors through the machine, and the cash remaining in the machine;
a reader to validate a personal identifier associated with a jury summons;
a display for a juror to interact with the machine; and
a dispensing mechanism to provide payment to the juror upon completion of jury service.

13. The juror-interaction machine of claim 12 wherein the display presents the juror with selection options, the selection options comprising:
accept payment, decline payment, and donate payment to a charity.

14. The juror-interaction machine of claim 12 wherein the reader is selected from the group comprising:
a handheld scanner, a portable laser scanner, a scannable image reader, a signal reader, and an RFID reader.

15. The juror-interaction machine of claim 12 wherein the personal identifier is selected from the group comprising:
a bar code, a QR code, a scannable image, an identifying signal, a string of numbers, a string of letters, a string of symbols, and combinations thereof

16. The juror-interaction machine of claim 12 further comprising:
at least one input device to respond to prompts on the display, the at least one input device selected from the group comprising:
a keyboard, a keypad, a PIN pad, a touch screen, and a tracking device.

17. The juror-interaction machine of claim 12 further comprising:
a camera to capture video clips and still images of the juror utilizing the juror-interaction machine.

18. The juror-interaction machine of claim 12 further comprising:
a vault from which the dispensing mechanism obtains payment to provide to jurors.

19. The juror-interaction machine of claim 12 further comprising:
at least one communication port to transmit and receive information about juror check-in status, payments made to jurors, and errors in operation of the machine.

20. The juror-interaction machine of claim 12 further comprising:
a record printer to provide a juror with a record of transactions with the juror-interaction machine.
